(19) United States
(12) Patent Application Publication
(10) Pub. No.: US 2025/0301352 A1
(43) Pub. Date: Sep. 25, 2025

(54) METRICS COLLECTION AND REPORTING FOR SPATIAL REUSE OF TRANSMISSION OPPORTUNITIES (TXOPS)

(71) Applicant: Cisco Technology, Inc., San Jose, CA (US)

(72) Inventors: Malcolm M. SMITH, Richardson, TX (US); Brian D. HART, Sunnyvale, CA (US)

(21) Appl. No.: 18/820,996

(22) Filed: Aug. 30, 2024

Related U.S. Application Data
(60) Provisional application No. 63/569,582, filed on Mar. 25, 2024.

(51) Int. Cl. H04W 24/10; H04W 24/08

(52) U.S. Cl. CPC H04W 24/10; H04W 24/08

(57) ABSTRACT

The present disclosure provides techniques for out-of-TXOP reporting of queue statistics for improved spatial reuse in wireless networks. A follower network device in a coordination group (CG) receives a reporting criterion from a leader network device in the CG. The follower network device sends a first queue statistics report to the leader network device. The follower network device monitors at least one of one or more channel conditions of a wireless network within the CG or one or more queue depth (QDepth) progresses related to the follower network device. The follower network device detects a deviation from the reporting criterion based on the monitoring. The follower network device sends a second queue statistics report to the leader network device.

### CROSS-REFERENCE TO RELATED APPLICATIONS

This application claims benefit of co-pending U.S. provisional patent application Ser. No. 63/569,582 filed Mar. 25, 2024. The aforementioned related patent application is herein incorporated by reference in its entirety.

### TECHNICAL FIELD

Embodiments presented in this disclosure generally relate to wireless communication. More specifically, embodiments disclosed herein relate to methods of collecting and reporting network metrics to improve spatial reuse of transmission opportunities (TXOPs) in wireless network environments.

### BACKGROUND

Shared transmit opportunities (TXOPs) can facilitate the reporting of statistics to a leader access point (AP) from the follower APs within the same coordination group (CG). This report, commonly referred to as the AP Queue Report (AQRP), includes detailed metrics such as the per-station (STA) queue depth (QDepth) and relevant parameters like the received signal strength indicator (RSSI) of each STA. These metrics, gathered by the follower APs, are important for effective STA-specific scheduling. However, implementing this reporting mechanism for every TXOP can be prohibitively expensive in terms of airtime and processing overhead. Furthermore, relying on historical data rather than reporting for each TXOP produces suboptimal results for multi-AP coordination (MAPC) spatial reuse (SR), as it fails to consider the dynamic nature of high-density Wi-Fi networks. Therefore, more efficient and adaptive reporting strategies are desired to improve network performance while reducing the associated costs.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example wireless network environment supporting multi-AP coordination (MAPC) for medium resource access, according to some embodiments of the present disclosure.

FIG. 2 depicts an example of in-TXOP traffic load reporting, according to some embodiments of the present disclosure.

FIG. 3 depicts an example sequence of interactions for pre-TXOP queue statistics reporting within a CG, according to some embodiments of the present disclosure.

FIG. 4 depicts an example method for channel coherence time-based (Tc-based) out-of-TXOP reporting within a CG, according to some embodiments of the present disclosure.

FIG. 5 depicts an example method for queue depth-based (QDepth-based) out-of-TXOP reporting within a CG, according to some embodiments of the present disclosure.

FIG. 6 is a flow diagram depicting a framework for metrics collection and reporting for improved spatial reuse of TXOPs, according to some embodiments of the present disclosure.

FIG. 7 depicts an example network device configured to perform various aspects of the present disclosure, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method for managing network traffic within a coordination group (CG), including receiving, by a follower network device in the CG, a reporting criterion from a leader network device in the CG, sending, by the follower network device, a first queue statistics report to the leader network device, monitoring, by the follower network device, at least one of one or more channel conditions of a wireless network within the CG or one or more queue depth (QDepth) progresses related to the follower network device, detecting, by the follower network device, a deviation from the reporting criterion based on the monitoring, and sending, by the follower network device, a second queue statistics report to the leader network device.

Other embodiments in this disclosure provide one or more non-transitory computer-readable media containing, in any combination, computer program code that, when executed by operation of a computer system, performs operations in accordance with one or more of the above methods, as well as systems comprising one or more computer processors and one or more memories collectively containing one or more programs, which, when executed by the one or more computer processors, perform operations in accordance with one or more of the above methods.

### Example Embodiments

The present disclosure provides techniques for out-of-TXOP collection and reporting of network metrics. The disclosed techniques effectively reduce airtime consumed by overhead communication, therefore enhancing overall network efficiency and improving spatial reuse of TXOPs in wireless environments.

In the multi-AP coordination group (MAPC), to facilitate effective spatial reuse, follower APs report queue statistics to the leader AP for resource allocation in shared TXOPs. The report, commonly referred to as the AQRP, includes detailed per-STA metrics such as QDepth, bit rate, RSSI, and/or other relevant parameters. Based on these metrics, the leader AP may make informed decisions for STA-specific scheduling and resource allocation. However, in large and high-density (HD) enterprise deployments, the overhead of exchanging these reports may consume significant airtime and processing resources, making it unviable for every TXOP.

For example, consider a HD enterprise deployment with 100 STAs per AP and 10 co-channel APs. In this configuration, the AQRP may involve reporting 4 bytes per metric for each of the 100 STAs, covering 8 different metrics. This results in a total of 3200 bytes (4 bytes×100 STAs×8 metrics) per TXOP. With 10 co-channel APs, each transmitting this report to the leader AP, there may be 10 exchanges per TXOP, consuming approximately a total of 2 milliseconds of airtime (10 exchanges×200 microseconds). Even with a larger 4-millisecond TXOP, the coordination overhead may consume half of the available airtime, significantly impacting overall network efficiency.

On the other hand, simply relying on historical data, such as the last 5 seconds of metrics collected by the leader AP, instead of real-time exchanges (like per-TXOP exchanges), is not sufficient for STA-specific MAPC SR scheduling. HD enterprise Wi-Fi environments are highly dynamic, with constant changes in user behavior, device locations, and interference patterns. Historical data, while useful for long-term trends and baseline understanding, fails to capture these rapid changes accurately. Relying solely on such data may lead to suboptimal or inaccurate scheduling decisions, as the current network conditions may significantly differ from those recorded seconds ago.

Embodiments of the present disclosure introduce a method where follower APs in the same CG selectively collect and report network metrics to the leader AP, specifically designed to avoid consuming airtime within TXOPs. In some embodiments, the collection and reporting of network metrics may be triggered based on channel coherence time (Tc), where the follower AP monitors both the time elapsed and channel conditions. Upon detecting that the Tc has expired or that channel conditions deviate from acceptable ranges (before Tc expiration), the follower AP may send an updated report to the leader AP. The report may include the updated queue status from all associated STAs, which enables the leader AP to perform appropriate adjustments in transmission scheduling and resource allocation. In some embodiments, the method may include monitoring the progress in QDepth, which indicates whether the queue within each station (STA) has been served since the last report. The progress in QDepth may be indicated by changes in sequence numbers or timestamps of the packets. If the progress exceeds a predefined threshold, indicating a significant portion of the queue has been cleared or transmitted after the last report, the follower AP may initiate the sending of a new report to the leader AP. As mentioned above, the report may include updates on the current queue statuses and other relevant metrics, providing the leader AP with the relevant information to optimize network performance and resource allocation. In some embodiments, the transmission of the traffic load report may be conducted out of TXOP, using management and/or control frames, such as AP beacons, fast initial link setup (FILS) mini-frames, AP-to-AP neighbor discovery protocol (NDP) frames, or out-of-TXOP STA-inclusive airtime AQRP.

The disclosed method shifts the collection and reporting of network metrics from per-TXOP to being based on channel conditions, Tc, and/or QDepth. Additionally, the method enables the transmission of reports without consuming airtime within TXOPs, leaving more bandwidth for data transmission. With the disclosed method, the leader AP may allocate resources based on updated metrics with assurance that the airtime within TXOPs will not be congested by excessive control traffic.

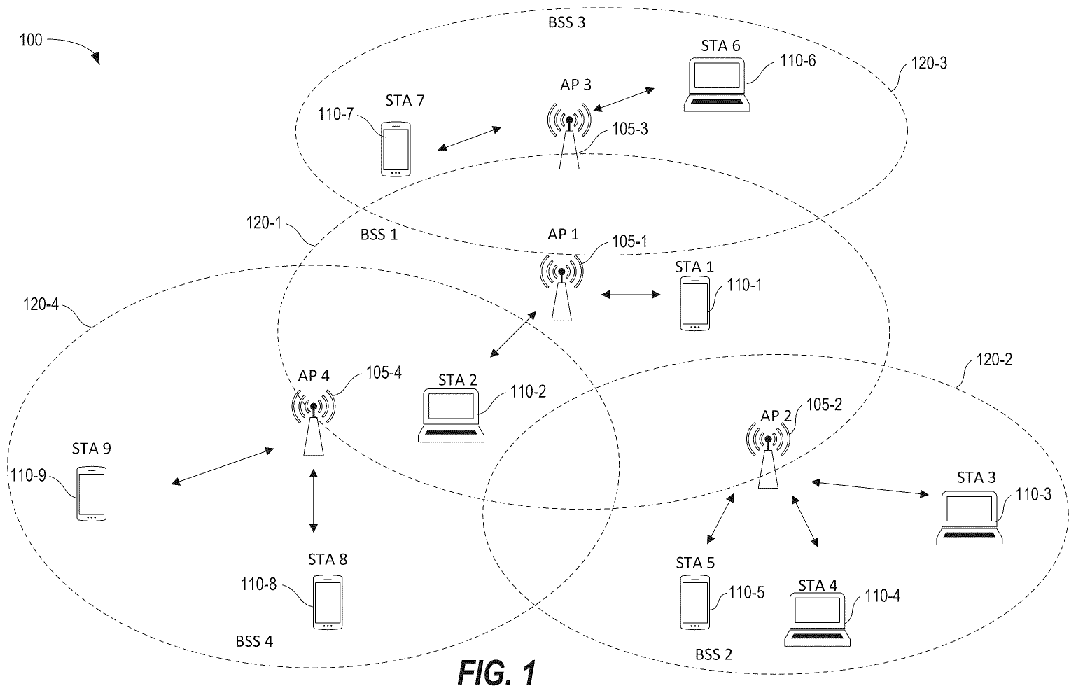

FIG. 1 depicts an example wireless network environment 100 supporting multi-AP coordination (MAPC) for medium resource access, according to some embodiments of the present disclosure.

This example environment 100 includes four Basic Service Sets (BSSs) (BSS 1, BSS 2, BSS 3, and BSS 4). Each BSS includes one access point (AP) and one or more station devices (STAs) that associated with the AP as members. For example, AP 1 (105-1) and its associated STA 1 (110-1) and STA 2 (110-2) form BSS 1. AP 2 (105-2) and its associated STA 3 (110-3), STA 4 (110-4), and STA 5 (110-5) form BSS 2. AP 3 (105-3) and its associated STA 6 (110-6) and STA 7 (110-7) form BSS 2. AP 4 (105-4) and its associated STA 8 (110-8) and STA 9 (110-9) form BSS 4. Each AP has a signal coverage area, such as AP 1 (105-1) having a signal coverage 120-1, AP 2 (105-2) having a signal coverage 120-2, AP 3 (105-3) having a signal coverage 120-3, and AP 4 (105-4) having a signal coverage 120-4. These four APs, along with their associated STAs, form a coordination group (CG) to facilitate spatial reuse of shared TXOPs. As depicted, AP 1 (105-1) is located approximately at the center of the CG, and serves as the leader AP, with others acting as follower APs.

Each follower AP may send a queue statistics report (also referred to in some embodiments as traffic load report or measurement report) to the leader AP, which includes detailed information that assists the leader AP in understanding and managing the shared network resources. Metrics within the queue statistics report may include, but are not limited to, per-STA QDepth, RSSI, noise levels, bit rate, and channel utilization. As used herein, per-STA Qdepth may refer to the number of data packets that are queued at each STA, awaiting their turns for transmissions over the network. The per-STA Qdepth may be used by leader AP to estimate the traffic load of each individual STA and/or properly allocate resources (e.g., resource units (RUs)) within the shared TXOPs. For example, STAs with higher QDepth may receive a greater share of bandwidth (e.g., RUs with 106 tones), to help clear their queues efficiently. In some embodiments, such as when the STAs in the CG are serving different types of applications (e.g., ranging from latency-sensitive video streaming to basic web browsing), the follower AP may report the per-STA QDepth along with the associated traffic identifier (TID), indicating the type of service and priority.

In the illustrated environment 100, the report sent by one or more APs (e.g., AP 2 (105-2)) may include detailed information (e.g., collected from STA 3 (110-3), STA 4 (110-4), and STA 5 (110-5)). For example, the reports may specify per-STA QDepth, with STA 3 having 50 packets queued, STA 4 having 30 packets queued, and STA 5 having 40 packets queued. In embodiments where the STA 3 (110-3) is serving applications for video streaming (or other higher priority traffic), while STA 4 (110-4) and STA 5 (110-5) are engaged in web browsing, the follower AP 2 (105-2) may report the per-STA QDepth along with its associated TID(s). This report may highlight the different data demands and priority levels of each STA's activities. With the detailed information, the leader AP may allocate resources not only based on the overall traffic load but also considering the specific requirements of each traffic type.

Upon receiving the queue statistics reports from follower AP 2 (105-2), AP 3 (105-3), and AP 4 (105-4), the leader AP 1 (105-1) may analyze the data to allocate resources (e.g., RUs) and schedule transmissions (e.g., TXOPs) for each requested STA. The resource allocation and scheduling may ensure that STAs with higher QDepth receive sufficient bandwidth. In embodiments where TID is reported along with per-STA QDepth, indicating the type of service and its priority, the leader AP 1 (105-1) may allocate resources (e.g., RUs) to ensure that high-priority traffic (e.g., video streaming in STA 3 (110-3)) is transmitted with optimal (or at least improved) performance.

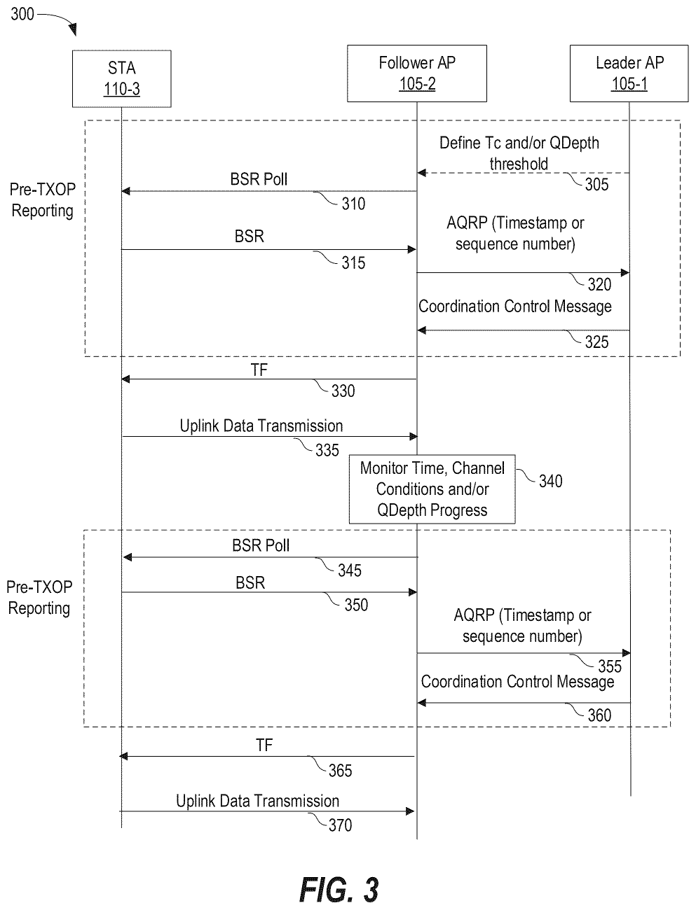

In the illustrated environment 100, when each follower AP reports the queue statistics to the leader AP during a TXOP, a total of three exchanges occur, one from each follower AP. Given that each follower AP has a limited number of associated STAs (e.g., AP 2 with three STAs, AP 3 with two STAs, and AP 4 with two STAs), the current traffic load reporting does not consume substantial airtime within TXOPs, making in-TXOP reporting viable in smaller CG configurations. However, as the CG expands to include more follower APs (also referred to in some embodiments as co-channel APs), each potentially with more associated STAs, traffic load reporting per TXOP may result in substantial airtime consumption. This extensive use of airtime for reporting may significantly impact the network's ability to manage data transmission efficiently. To address the scalability issue, mechanisms for shifting traffic load reporting out of TXOP may be implemented. More detail regarding the out-of-TXOP reporting is discussed below with reference to FIGS. 3, 4, and 5.

In some embodiments, other types of network devices, such as wireless controllers (WLCs), routers, or dedicated resource allocation servers, may handle the reception of queue statistics reports and the allocation of resources across the CG. All the APs in the CG, including AP 1 (105-1), AP 2 (105-2), AP 3 (105-3), and AP 4 (105-4), may report their queue statistics to the control device, which then analyzes the data to allocate RUs and schedule TXOPs for requested STAs.

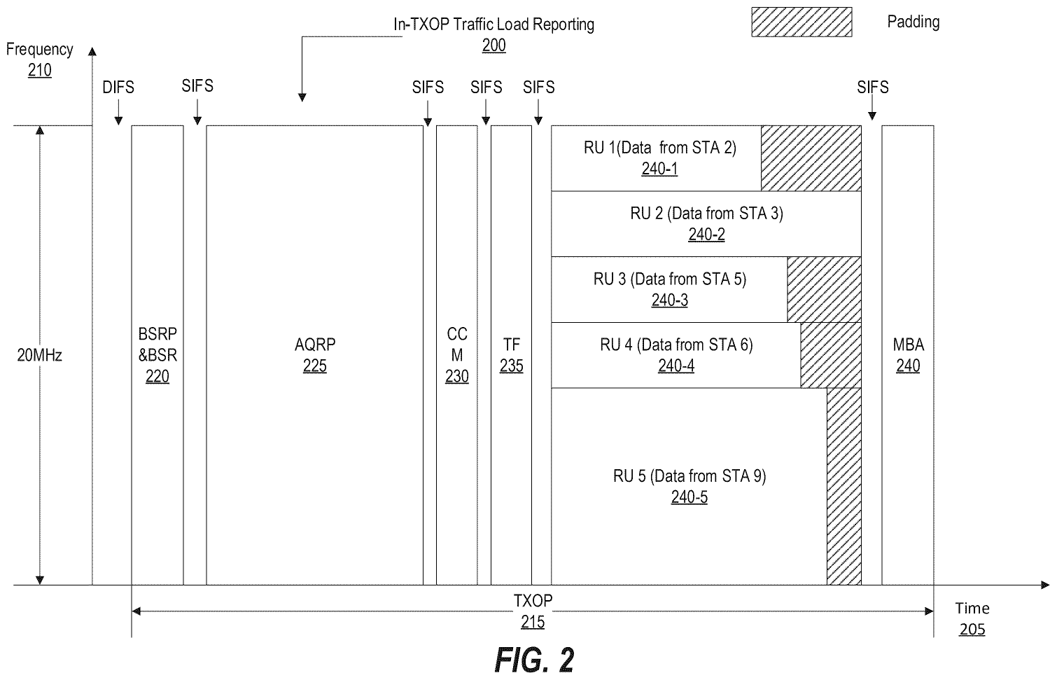

FIG. 2 depicts an example of in-TXOP traffic load reporting 200, according to some embodiments of the present disclosure. The figure illustrates the sequential exchange of multiple control messages and uplink data transmissions within a single TXOP 215, where the horizontal axis (x-axis) represents time 205 and the vertical axis (y-axis) represents frequency 210.

At the beginning of the TXOP 215, buffer status report polls (BSRPs) and buffer status reports (BSRs) are exchanged between APs (e.g., AP 2 (110-2) of FIG. 1) and their associated STAs (e.g., STA 3 (110-3), STA 4 (110-4), and STA 5 (110-5) of FIG. 1) within a 20 MHz sub-channel. The BSRs 220 provide the AP with information about the data queued at each STA and other relevant metrics, like RSSI, bit rate, and more. Following the initial exchange of BSRs, AQRPs 225 are sent by follower APs (e.g., AP 2 (110-2), AP 3 (110-3), and AP 4 (110-4) of FIG. 1) to the leader AP (e.g., AP 1 (110-1) of FIG. 1) using the 20 MHz sub-channel. In some embodiments, the AQRPs 225 may include data reported by each STA, including QDepth, RSSI, bit rate, and other relevant data. These reports inform the leader AP of the traffic load within each individual STA. Based on the reported data, the leader AP may make informed decisions regarding transmission scheduling and resource allocation across the CG.

After receiving and reviewing the AQPR data, the leader AP sends out a coordination control message (CCM) 230 to each follower AP using the 20 MHz sub-channel. In some embodiments, the CCM may include instructions for resource allocation and scheduling for each requested STA, which are determined based on the latest queue status data and/or network condition information provided by the AQRPs 225. Following the receipt of the CCM 230, each follower AP sends a trigger frame (TF) 235 to their respective STAs. These TFs 235 may specify the exact timing and frequency allocations for the uplink transmissions, such as which RU 240 each STA should use to transmit and/or receive their data within the scheduled TXOP 215. Such in-TXOP collection and reporting of network metrics help to optimize the use of available airtime across the CG, and reduce potential interference among the transmissions.

As depicted, the uplink data transmissions are initiated following the instructions within the TFs 235. RU 1 (240-1) is allocated to STA 1 (e.g., STA 1 (110-1) of FIG. 1), RU 2 (240-2) is allocated to STA 3 (e.g., STA 3 (110-3) of FIG. 1), and so forth, each utilizing separate parts of the 20 MHz spectrum for uplink data transmissions. Following the data transmissions, the TXOP 215 concludes with multi-user block acknowledgments (MBAs) 245, which are sent by each AP to confirm the successful reception of all uplink transmissions during the TXOP.

In some embodiments, such as when a STA has a higher QDepth, suggesting a large number of data packets awaiting transmission, a RU with wider bandwidth may be allocated to the STA to facilitate efficient data handling and reduce transmission delays. In some embodiments, such as when per-STA QDepth metrics are reported along with TID, data associated with services of high priority, such as video streaming, may be assigned a wider RU compared to other services that may not require immediate or high-speed transmission. As depicted, RU 5 (240-5) has a wider bandwidth than other RUs (e.g., RUs 1, 2, 3, and 4) and is assigned to STA 9 (e.g., STA 9 (110-9) of FIG. 1). Such allocation may be due to STA 9 having a high QDepth or a TID indicating a high priority for its data traffic.

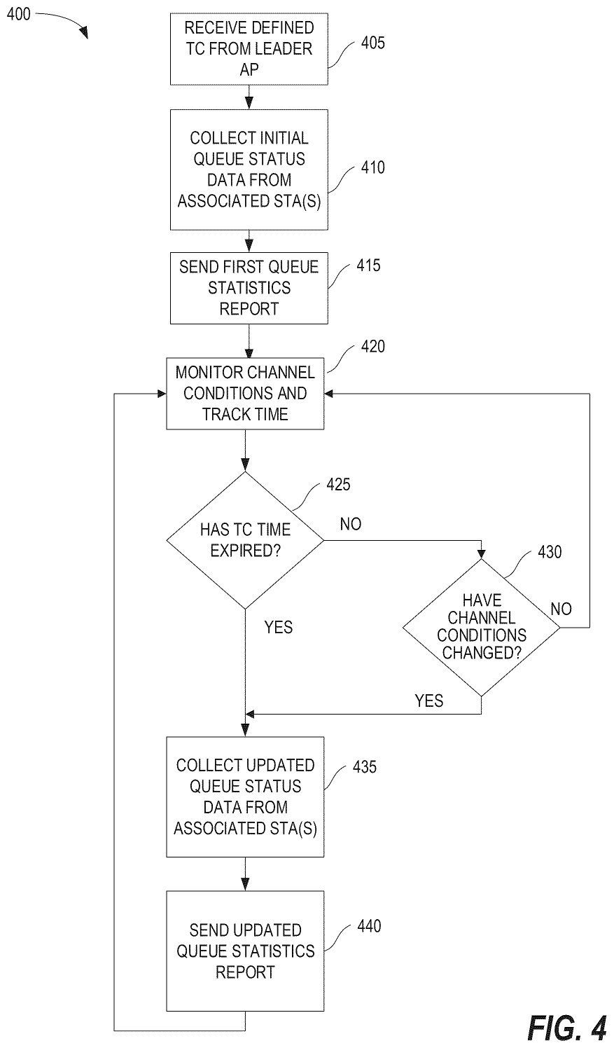

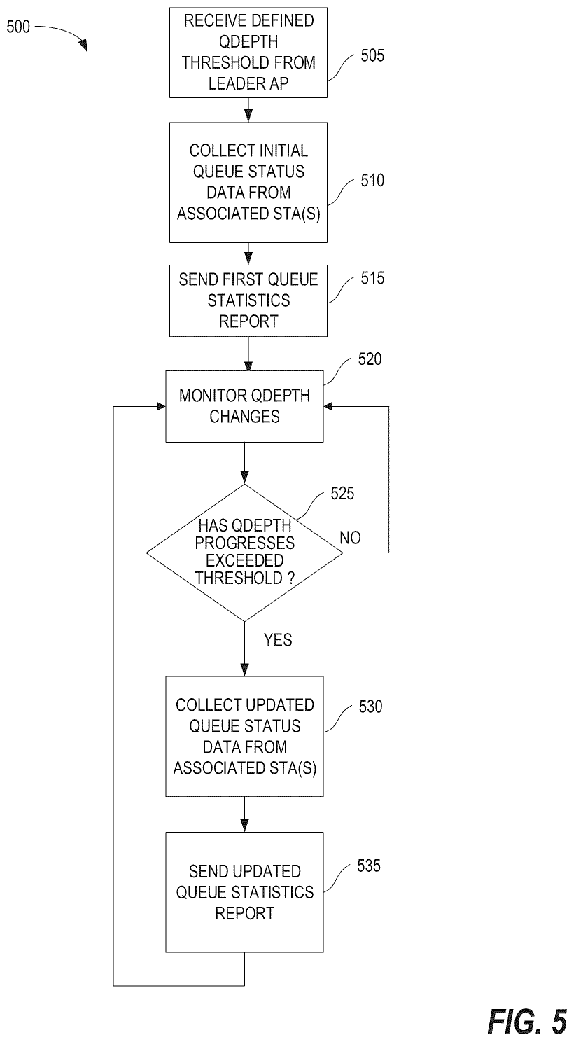

As illustrated, the transmission of traffic load reports (also referred to in some embodiments as queue statistics reports or measurement reports) (e.g., AQRP 225) by follower APs to the leader AP consumes a substantial portion of airtime within the TXOP 215. This may lead to less available airtime for actual data transmission, resulting in delays and reduced network throughput. To optimize spatial reuse across the CG, the transmission of the traffic load reports 225 can be shifted to out-of-TXOP periods. Follower APs are set to send these reports directly to the leader AP using management and/or control frames, such as AP beacons, FILS mini-frames, and AP-to-AP NDP frames. Additionally, in this configuration, traffic load reporting is no longer routinely scheduled per TXOP. Instead, the reporting is triggered based on specific reporting criteria, such as the expiration of Tc, changes in channel conditions (e.g., RSSI, bit rate), or observed progress observed in per-STA QDepth. This adjustment allows the follower APs to adapt reporting frequency to the actual network environments, significantly reducing unnecessary overhead communications and preserving airtime for actual data transmission. In some embodiments, the traffic load reporting within TXOP periods may initially be maintained to use the synchronous communication channels already established. However, to prevent excessive consumption of TXOP time, a performance threshold may be implemented by the leader AP or a WLC. This threshold is designed to monitor the proportion of TXOP time consumed by overhead activities such as reporting, compared to time spent on actual data transmission. A limit may be set, for example, where no more than 20% of the TXOP should be allocated to reporting overhead. When monitoring reveals that the threshold is exceeded (e.g., ≥20%), indicating that reporting activities are disproportionately consuming TXOP and potentially degrading overall network performance, traffic load reporting may then be shifted to out-of-TXOP periods. More detail regarding the out-of-TXOP reporting is discussed with reference to FIGS. 4 and 5.

FIG. 3 depicts an example sequence of interactions 300 for pre-TXOP queue statistics reporting within a CG, according to some embodiments of the present disclosure.

In some embodiments, the leader AP 105-1 may correspond to the AP 1 (105-1) as depicted in FIG. 1, the follower AP 105-2 may correspond to the AP 2 (105-2) as depicted in FIG. 1, and the STA 110-3 may corresponds to the STA 3 (110-3) as depicted in FIG. 1. The leader AP 105-1 and the follower AP 105-2 are part of the same CG, coordinating to manage shared TXOPs. The STA 110-3 is associated with the follower AP 105-2.

As illustrated, the leader AP 105-1 defines and communicates the Tc and/or QDepth thresholds to follower AP 105-2 (step 305). These parameters set up one or more out-of-TXOP queue statistics reporting criteria (also referred to in some embodiments as out-of-TXOP traffic load reporting criteria), to ensure that network resources are used efficiently and only necessary reports are transmitted to maintain network performance.

As used herein, the Tc may refer to the duration of time (e.g., 100 milliseconds) over which the wireless channel's properties, such as RSSI, noise levels, or bit rate, remain relatively stable (e.g., maintaining 90% similarity). In some embodiments, the Tc may be estimated based on a combination of environmental factors, such as physical obstructions and the density of wireless networks in the areas, as well as historical channel performance data. The out-of-TXOP traffic load reporting mechanism, designed based on Tc, may be triggered either when the Tc expires, or prior to the expiration of Tc if there is a significant deviation from the channel properties that were previously recorded. For example, an unexpected decrease in RSSI that cause the similarity of the channel conditions to drop below 90% before the Tc expires would trigger this reporting mechanism.

As used herein, the QDepth threshold may establish a specific limit to which the extent of queue servicing after the last report (e.g., 100 packets) can be considered significant enough to warrant updated reporting. This threshold may serve as a baseline for determine when the reduction in queue length has reached a level where the leader AP may improve results by adapting the resource allocation or scheduling strategies. As used herein, the progress in per-STA QDepth may refer to the number of packets within a queue that have been served/transmitted since the last report. If per-STA QDepth progress exceeds the threshold, indicating a significant portion of the queue has been served after the last report, it triggers the follower AP 105-2 to generate and send an updated traffic load report to the leader AP 105-1.

In embodiments where different follower APs experience varying channel conditions, due to differences in physical location, types of physical obstructions, or different user densities, each follower AP may set its own Tc, QDepth threshold, or other relevant parameters based on local conditions. In such a configuration, the follower APs may communicate their locally set parameters/thresholds to the leader AP 105-1, to ensure that these settings do not conflict with or interfere with the overall network strategies.

After setting up the queue statistics reporting criteria, the follower AP 105-2 initiates the process by sending a BSRP to STA 110-3 (step 310). The poll is designed to inquire about the current queue status of the STA. In response, the STA 110-3 sends a BSR to the follower AP 105-2 (step 315), which provides detailed information about the length of its queue (QDepth) and other relevant metrics such as RSSI and bit rate that are helpful in resource management. Although the figure only depicts the BSRP being sent to STA 110-3, in some embodiments, the BSRP may be sent to each associated STA, including STAs 110-3, 110-4, and 110-5, as depicted in FIG. 1. Each STA may then send back a BSR to the AP 105-2.

Upon receiving the BSRs from all associated STAs (or after a designated time has expired), the follower AP 105-2 aggregates these per-STA QDepth metrics into a queue statistics report, and sends the report to the leader AP 105-1 (step 320). In some embodiments, the queue statistics report may also be referred to as AQRP, which captures and consolidates the queue status data from multiple STAs. The figure that depicts the AQRP being sent by follower AP 105-2 to leader AP 105-1 is provided for conceptual clarity only. In some embodiments, each follower AP (also referred to in some embodiments as co-channel APs), including APs 105-2, 105-3, and 105-4, as depicted in FIG. 1, may send a respective AQRP to the leader AP 105-1, indicating the queue status data from its associated STAs. The AQRPs from follower APs in the CG, when compiled together, provide the leader AP 105-1 with a detailed view of the network's current traffic demands.

In some embodiments, the AQRPs may include the sequence number or timestamp of the first packet in the queue of each STA. The sequence number or timestamp may be tagged when a packet is added to the queue, indicating when the packet enters the line for transmission. In some embodiments, the sequence number may increase as more packets are added, such as sequence number “1” for the first added packet, sequence number “2” for the second added packet, and so forth. The timestamps may mark the specific time each packet is queued, such as the UNIX timestamp of “100” for the first added packet, representing the first packet being added 100 milliseconds after a defined reference point (e.g., Jan. 1, 1970, at 00:00:00 UTC), and the UNIX timestamp of “101” for the second added packet, representing the first packet being added 101 milliseconds after the defined reference point. The information allows follower APs to determine whether packets within each STA have been successfully transmitted after the report is generated. As discussed above, for the purpose of queue statistic reporting by follower AP to leader AP, the QDepth threshold may refer to a limit beyond which the extent of queue servicing after a report can be considered significant and an updated queue statistic report is required. QDepth progress may refer to the advancement or reduction in the per-STA QDepth, specifically focusing on the number of packets that have been successfully transmitted since the last report. The progress may be determined either by checking the sequence numbers or by evaluating the timestamps. For example, the follower AP may check the sequence number or timestamp of the first packet in each STA's queue and compare it with previously recorded data to determine the per-STA QDepth progress. If the queue has been served, the sequence number of the first packet in the queue (e.g., the sequence number of “233”) should be higher than the previously recorded sequence number (e.g., the sequence number of “200”), and the timestamp of the first packet in the queue (e.g., the UNIX timestamp of “110”) should be a later time than the recorded timestamp (e.g., the UNIX timestamp of “100”).

The leader AP 105-1 analyzes the data within the AQRPs. Based on the analysis, the leader AP 105-1 schedules TXOPs and allocates RUs across the CG, to ensure that the data queued in each device within the CG is properly transmitted based on its priority and other specific quality requirements. The leader AP then sends a coordination control message (CCM) to the follower APs, including AP 105-2 (step 325). The CCM may detail TXOP scheduling, RU allocations, and other management instructions. The control message exchanges, as depicted in steps 305-325, including the setup of reporting criteria, the collection of queue statuses from STAs, the reporting of queue status to leader AP, and the transmission of CCM, may all occur per-TXOP. Such a preemptive arrangement allows for all necessary communication and management decisions to be completed before the actual TXOPs begin. This strategy optimizes (or at least improves) TXOP usage by saving more airtime for actual data transfer rather than consuming it with overhead control exchanges. In some embodiments, these control messages may be exchanged using management or control frames, such as AP beacons (typically sent every 100 ms), FILS mini-frames (typically sent every 20 ms), AP-to-AP NDP frames, or other specific protocols designed for efficient network administration.

As the TXOP arrives, follower AP 105-2, guided by the information within the CCM, identifies the scheduled TXOP. The follower AP 105-2 then proceeds to send a TF to the STA 110-3 (step 330). In some embodiments, the TF may specify the exact RUs allocated to the STA 110-3, defining the frequency bands and time intervals during which the STA is permitted to transmit uplink data. The STA 110-3 transmits its uplink data using the allocated RUs as instructed by the TF (step 335).

Following the receipt of uplink data from STA 110-3, the follower AP 105-2 continues to track time for Tc, and/or monitor one or more channel metrics (e.g., RSSI, SNR, SINR, bit rate) and QDepth progress to determine whether the defined reporting criteria have been triggered (step 340). If none of these criteria are triggered—such as if the Tc has not expired, channel conditions remain stable, indicating more than 90% similarity, and Qdepth progress does not exceed the established threshold—the follower AP 105-2 may continue to use the previously received CCM to prepare and issue TF for subsequent TXOPs. This continuous monitoring ensures that network operations are maintained efficiently, with adjustments made only when necessary based on real-time data and predetermined thresholds.

If any of these reporting criteria are triggered—such as the expiration of Tc, deviations indicating less than 90% similarity in channel properties compared to previously recorded baselines, or if QDepth progress exceeds the threshold, indicating that a substantial portion of the queue has been transmitted—the follower AP 105-2 takes further actions to ensure accurate network management. As illustrated, the follower AP 105-2 sends a BSRP to STA 110-3 (and other associated STAs) (step 345), and collects a BSR in response (step 350). The BSR may provide updated queue status data, indicating the current queue lengths and other relevant parameters. Upon receiving the updated BSRs, the follower AP 105-2 compiles the data into an updated queue statistics report and sends it to the leader AP 105-1 (step 355). The report informs the leader AP 105-1 of the updated per-STA QDepth and other metrics. Based on the report, the leader AP 105-1 adjusts resource allocation and transmission scheduling, and sends out a new CCM to the follower AP 105-2 (step 360). Upon receiving the new CCM, the follower AP 105-2 identifies the next TXOP based on the instructions, and issues a TF to STA 105-3, indicating the specific RUs allocated for its use (step 365). The STA 105-3 then transmits its uplink data using the allocated RUs during the designated TXOP (step 370).

In some embodiments, the follower AP 105-2 may also report data such as elapsed time, indicators of channel quality (e.g., SNR, RSSI, SINR, and bit rate), and QDepth progress to the leader AP 105-1. Upon receiving the data, the leader AP 105-2 may assess whether the conditions meet the predefined criteria for triggering reporting or network adjustments. Upon determining that the reporting criteria have been met, the leader AP 105-1 may communicate this assessment back to the follower AP 105-2, such as through a CCM. Once receiving the message, the follower AP 105-2 may proceed to collect updated queue status data from the associated STAs (steps 345 and 350). The follower AP 105-2 may then compile the data into an updated queue statistics report and send it back to the leader AP 105-1 (step 355).

In some embodiments, the indicators of channel quality reported by the follower AP 105-2 may be gathered through direct monitoring methods, such as measuring the uplink signals directly at the AP. For downlink signals, where data is transmitted from the AP 105-2 to the STA 110-3, the follower AP 105-2 may utilize direct polling methods, which include sending requests to the associated STAs for beacon reports or other types of feedback (step 345). In some embodiments, the beacon reports may include detailed data on the radio environment as measured by each respective STA.

In downlink data transmission, the follower AP typically retains full control over the resource allocation and can adjust these based on instantaneous data rates. Consequently, there is typically no requirement for the follower AP to report queue statistics to the leader AP for downlink data transfer, as each AP can manage its downlink transmission autonomously. The out-of-TXOP reporting mechanism is depicted in FIG. 3 as implemented for uplink data transmission. In some embodiments, the disclosed mechanism may be adapted to downlink data transmission if necessary. For example, in embodiments where there are significant changes in network demands or congestion issues that may affect multiple APs within the CG, out-of-TXOP reporting for downlink data may be implemented to more effectively coordinating responses and resource allocation across the network.

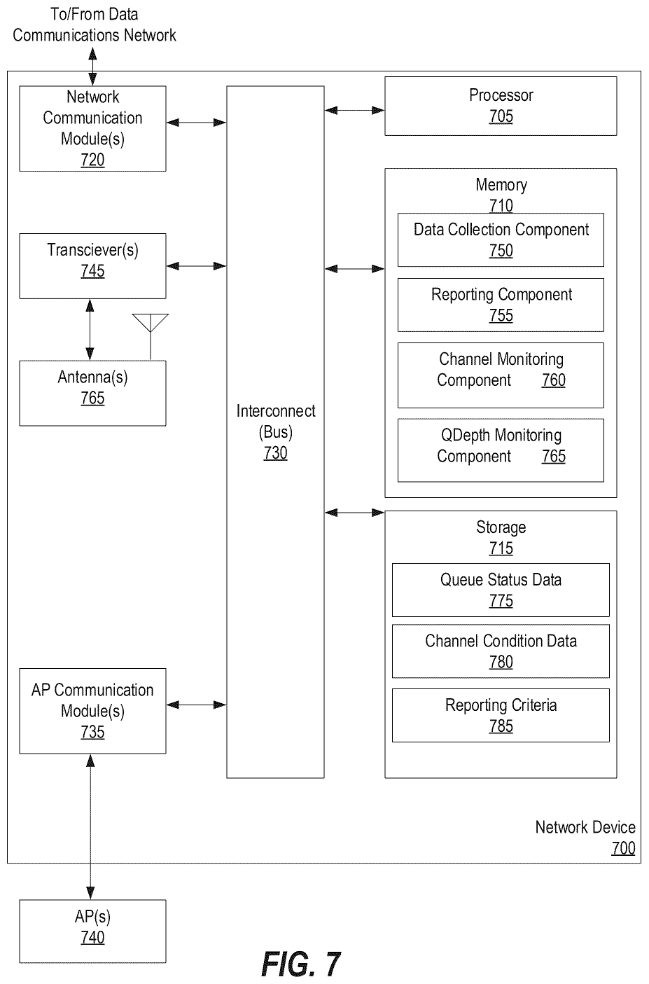

FIG. 4 depicts an example method 400 for Tc-based out-of-TXOP reporting within a CG, according to some embodiments of the present disclosure. In some embodiments, the method 400 may be performed by a follower AP within a CG for spatial reuse, such as the APs 105-2, 105-3, and 105-4 as depicted in FIG. 1, the AP 105-2 as depicted in FIG. 3, and the network device 700 as depicted in FIG. 7.

The method 400 begins at block 405, where a follower AP (e.g., 105-2 of FIG. 1) receives defined channel coherence time (Tc) from the leader AP (e.g., 105-1 of FIG. 1) within the same CG. As discussed above, Tc defines the period of time (e.g., 100 milliseconds) during which the channel conditions are expected to remain stable (e.g., 90% similarity to baseline conditions) and not require another report. The channel conditions that may be monitored may include signal strength (e.g., RSSI), noise levels (e.g., ambient noise in dBm), bit rate (e.g., bits per second transferred over a network channel), interference patterns (e.g., overlapping signals from other devices), channel utilization (e.g., percentage of time the channel is actively transmitting), and other environmental factors.

At block 410, the follower AP collects initial queue status data from each associated STA (e.g., 110-3 of FIG. 1), which includes BSRs detailing the number of data packets queued at each STA (e.g., per-STA QDepth), awaiting uplink transmission over the network.

At block 415, the follower AP aggregates the collected data (e.g., per-STA QDepth) into a queue statistics report (also referred to in some embodiments as traffic load report or measurement report) (e.g., AQRP), and sends the first report to the leader AP. In some embodiments, after the initial reporting, the follower AP may receive a CCM from the leader AP, which contains detailed instructions for TXOP scheduling and resource allocations to specific STAs. Using the information within the CCM, the follower AP may instruct associated STAs (e.g., by sending TFs) on how to perform their uplink transmissions within the defined parameters.

At block 420, the follower AP tracks the time to determine whether the Tc has expired, and monitors the channel conditions over time. In some embodiments, the monitoring of channel conditions may involve comparing the current channel conditions against the Tc baselines to detect any changes that result in the similarity dropping a defined percentage (e.g., 90%) from these baselines.

At block 425, the follower AP determines whether the Tc has expired. If the Tc has expired (e.g., reaching 100 milliseconds), the method 400 proceeds to block 435. If the Tc has not yet expired, the method 400 moves to block 430, where the follower AP checks whether there have been any channel condition changes significant enough to make the similarity drop below a predefined threshold (e.g., 90% similarity) before the Tc expires. If any significant channel condition changes are detected that result in a drop in similarity, the method 400 proceeds to block 435. If neither condition from blocks 425 and 430 is met (e.g., Tc has not expired and channel conditions remain stable within the similarity threshold), the method 400 returns to block 420, where the follower AP continues its monitoring operations. The proactive check and verification allows the follower AP to remain responsive to any changes in channel conditions, to ensure that TXOP scheduling and resource allocation across the CG can be adapted to dynamic environmental changes.

At block 435, the follower AP collects updated queue status data and relevant channel metrics from the associated STAs. At block 440, the follower AP generates an updated queue statistics report, and sends it to the leader AP. Following the submission of the updated report, in some embodiments, the follower AP may receive a new CCM from the leader AP. The new CCM may include new instructions based on the updated queue status data and channel metrics, potentially adjusting resource allocations, scheduling new TXOPs, or changing parameters for data transmission. Using the information within the updated CCM, the follower AP may instruct the associated STAs for uplink data transmission.

In some embodiments, the follower AP may report the elapsed time and indicators of channel conditions (e.g., RSSI, SNR, SINR) to the leader AP. The leader AP, after receiving the data, may evaluate whether the Tc has expired (as depicted by block 425) or whether there have been significant changes in channel conditions that cause the similarity drop below a defined threshold (e.g., 90%) (as depicted by block 430). If either condition is met, the leader AP proceeds to send a control message (e.g., CCM) to the follower AP, directing it to initiate detailed data collection. Following the instructions, at block 435, the follower AP collects updated queue status data and relevant channel metrics from the associated STAs. At block 440, the follower AP prepares the data within an updated queue statistics report and sends it back to the leader AP. The leader AP, upon receiving the updated report, may issue a new CCM to the follower AP. The message may contain specific instructions for adjusting resources allocations based on the latest data. Following the instructions, the follower AP may then implement the adjusted resources to optimize network performance and meet the current demands of its associated STAs.

FIG. 5 depicts an example method 500 for QDepth-based out-of-TXOP reporting within a CG, according to some embodiments of the present disclosure. In some embodiments, the method 500 may be performed by a follower AP within a CG for spatial reuse, such as the APs 105-2, 105-3, and 105-4 as depicted in FIG. 1, the AP 105-2 as depicted in FIG. 3, and the network device 700 as depicted in FIG. 7.

At block 505, a follower AP (e.g., 105-2 of FIG. 1) receives a defined QDepth threshold from the leader AP (e.g., 105-1 of FIG. 1) within the same CG. As used herein, the QDepth threshold may establish a baseline for when progress in the queue status is significant enough to warrant reporting and potential adjustments in network management. In some embodiments, the QDepth may include a numerical value that indicates the number of data packets in the queue that have been successfully transmitted after the last report. For example, the QDepth threshold may be set at 50 packets, representing that an update is required when the number of packets transmitted from the queue since the last report reaches or exceeds this number. By setting specific thresholds for reporting based on significant progress in queue depth, this approach captures the dynamic conditions of the network, to ensure effective TXOP scheduling and resource allocation without the continuous overhead of per-TXOP-based reporting.

At block 510, the follower AP collects initial queue status data from each associated STA (e.g., 110-3 of FIG. 1). In some embodiments, the follower AP may send BSRP to each associated STA, and in response, each STA may report its current queue status using BSRs.

At block 515, the follower AP aggregates the collected data into a queue statistics report (e.g., AQRP), and sends the first report to the leader AP. In some embodiments, the report may include the sequence number (e.g., the sequence number of “200”) or timestamp (e.g., the UNIX timestamp of “100”) of the first packet within each STA's queue, which may be set as a baseline for further comparison. In some embodiments, after the follower AP sends the first report, the leader AP may analyze the queue statistics and channel conditions data provided in the report. Based on the analysis, the leader AP may schedule TXOPs and allocate RUs across the CG to optimize (or at least improve) network performance and maintain efficient data flow. The scheduling and resource allocation may then be included within a CCM, which is sent by leader AP to the follower AP. Relying on the instructions within the CCM, the follower AP may guide the associated STAs for uplink data transmission.

At block 520, the follower AP monitors the QDepth progress within each associated STA to determine whether a substantial portion of the queue has been transmitted after the first report. In some embodiments, the monitoring may involve checking the sequence number and/or timestamp of the packet currently at the front of the queue (e.g., the first packet in the queue), and comparing these metrics with the baseline established in the first report. For example, if the first report indicates that the sequence number of the first packet in an STA's (e.g., STA 110-3) was “100,” and the subsequent continuous reporting by the STA reveals that the first packet in the queue now has a sequence number of “200,” this change may indicate that 100 packets have been transmitted since the first report. Alternatively, if the first report indicates the timestamp of the first packet in the queue was recorded as 100 milliseconds since a certain reference point (e.g., Jan. 1, 1970, at 00:00:00 UTC), and the follower AP later detects that the first packet in the queue now has a timestamp of 200 milliseconds, this increment may indicate that the new packets have been added and older packets have been successfully transmitted over that period. By monitoring the sequence number or timestamp of the packets within each STA's queue, the follower AP may determine whether the per-STA QDepth progress warrants updated reporting and potential adjustments in network management.

At block 525, the follower AP assesses whether the QDepth progress meets or exceeds the defined threshold. As discussed above, the QDepth threshold is established to mark the extent of queue servicing that can be considered significant enough to warrant updated reporting. In some embodiments, the threshold may be defined numerically (e.g., a reduction of 100 packets) or based on a time metric (e.g., a reduction of queued packets over a specified time interval, like 200 milliseconds since the last report). If the QDepth progress (indicated by the gap between the recorded sequence number at the time of the last report and the current sequence number, or changes between the recorded timestamp and the current timestamp) exceeds or meets the threshold, the method 500 proceeds to block 530, where the follower AP collects updated queue status data from associated STAs. If the QDepth progress does not meet the threshold, the method 500 returns to block 520, where the follower AP continues to monitor the queue length, to ensure that changes are tracked and assessed against the threshold.

At block 530, the follower AP collects updated queue status data from associated STAs. The data collection may involve requesting new BSRs from each STA, which detail the current queue lengths and any changes from the first report.

At block 535, the follower AP generates an updated queue statistics report, including all the data collected from associated STAs, including current queue lengths, sequence numbers, and timestamps. The follower AP then sends the updated report to the leader AP. In some embodiments, the follower AP may receive a new CCM from the leader AP after the updated report is reviewed. The new CCM may reflect necessary adjustments in network management based on the updated data, such as updated TXOP scheduling and RU allocations. Following the receipt of CCM, the follower AP may coordinate uplink data transmission among the associated STAs by communicating the specific TXOP timing and RUs allocated to each STA.

Although the Tc-based out-of-TXOP reporting method 400 and QDepth-based out-of-TXOP method 500 are depicted separately in FIGS. 4 and 5 for clarity, in some embodiments, the two reporting criteria may be implemented concurrently. For example, a network may use Tc criterion to ensure timely updates based on the stability of channel conditions, while simultaneously utilizing the QDepth criterion to monitor and respond to changes in data queue lengths at the STAs.

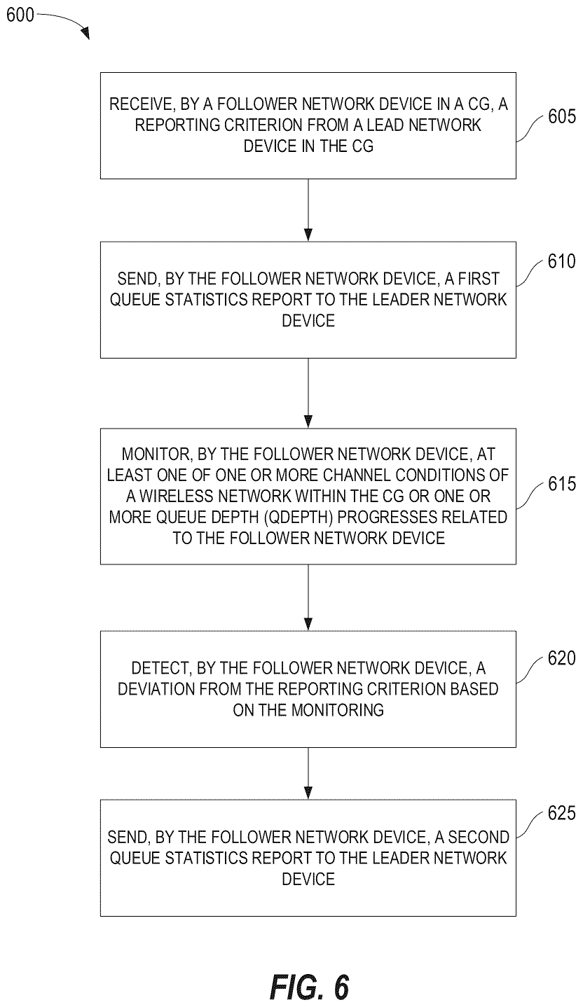

FIG. 6 is a flow diagram depicting a framework for metrics collection and reporting for improved spatial reuse of TXOPs, according to some embodiments of the present disclosure.

At block 605, a follower network device (e.g., AP 105-2 of FIG. 1) in a coordination group (CG) receives a reporting criterion (e.g., defined Tc or QDepth threshold) from a leader network device in the CG (e.g., AP 105-1 of FIG. 1). In some embodiments, the reporting criterion may comprise a channel coherence time (Tc), comprising a set of values that define thresholds for the one or more channel conditions, and an expiration time indicating when the set of values should be reassessed or when the Tc expires. In some embodiments, the reporting criterion may comprise the QDepth threshold.

At block 610, the follower AP sends a first queue statistics report to the leader network device (as depicted by step 320 of FIG. 3).

At block 615, the follower network device monitors at least one of one or more channel conditions of a wireless network within the CG or one or more queue depth (QDepth) progresses related to the follower network device (as depicted by step 340 of FIG. 3).

At block 620, the follower network device detects a deviation from the reporting criterion based on the monitoring. In some embodiments, the detection of the deviation may comprise the follower AP detecting changes in the one or more channel conditions exceeding the thresholds defined in the To, or the expiration time being reached. In some embodiments, the detection of the deviation may comprise the follower AP detecting at least one of the one or more QDepth progresses exceeding the QDepth threshold.

At block 625, the follower AP sends a second queue statistics report to the leader network device (as depicted by step 355 of FIG. 3).

In some embodiments, subsequent to detecting the deviation, the follower network device may collect queue status data from one or more client devices, each associated with the follower network device, where the queue status data are included within the second queue statistics report.

In some embodiments, the first queue statistics report may comprise a sequence number of a packet, and the packet may be a first packet in a queue at a time of generating the first queue statistics report, and is awaiting to be transmitted by a client device to the follower network device.

In some embodiments, to monitor the one or more QDepth progresses, the follower AP may compare the sequence number within the first queue statistics report with a sequence number of a new packet, where the new packet is the first packet in the queue at a time of monitoring the QDepth progress, and is awaiting to be transmitted by the client device to the follower network device.

In some embodiments, the first queue statistics report may comprise a timestamp of a packet, and the packet may be a first packet in a queue at a time of generating the first queue statistics report, and is awaiting to be transmitted by a client device to the follower network device.

In some embodiments, to monitor the one or more QDepth progresses, the follower AP may compare the timestamp within the first queue statistics report with a timestamp of a new packet, where the new packet is the first packet in the queue at a time of monitoring the QDepth progress, and is awaiting to be transmitted by the client device to the follower network device.

In some embodiments, the follower network device may comprise an access point (AP), and the leader network device may comprise at least one of an AP, a router, or a wireless controller (WLC).

In some embodiments, the one or more channel conditions may comprise at least one of signal strength, noise level, interference measurement, channel utilization, and bit rate.

In some embodiments, the queue statistics report may comprise at least one of current queue statuses, traffic load data related to devices associated with the follower network device, or changes in the one or more channel conditions.

In some embodiments, the leader network device may adjust resource allocations within the CG based on the second queue statistic report.

In some embodiments, the first and second queue statistics reports may be sent by the follower network device out of a scheduled transmission opportunity (TXOP).

FIG. 7 depicts an example network device 700 configured to perform various aspects of the present disclosure, according to some embodiments of the present disclosure. In some embodiments, the network 700 may correspond to a follower AP in a CG, such as the AP 2 (105-2), AP 3 (105-3), and AP 4 (105-4), as depicted in FIG. 1, or AP 105-2 as depicted in FIG. 3. In some embodiments, the network device 700 may communicate with the leader AP or other types of network devices (e.g., WLC) through wired and/or wireless links.

As illustrated, the network device 700 includes a processor 705, memory 710, storage 715, one or more transceivers 745, one or more AP communication modules 735, and one or more network communication modules 720. Each of the components is communicatively coupled by one or more buses 730. In some embodiments, one or more antennas may be coupled to the transceivers 745 for transmitting and receiving wireless signals.

The memory 710 may include random access memory (RAM) and read-only memory (ROM). The memory 710 may store processor-executable software code containing instructions that, when executed by the processor 705, enable the device 700 to perform various functions described herein for wireless communication. In the illustrated example, the memory 710 includes four software components: the data collection component 750, the reporting component 755, the channel monitoring component 760, and the QDepth monitoring component 765. In some embodiments, the data collection component 750 may collect queue status data (e.g., queue lengths, sequence numbers of the packets, and timestamps) and other relevant parameters (e.g., RSSI, bit rate) from associated client devices. In some embodiments, the reporting component 755 may organize the collected data (by the data collection component 750) into a queue statistic report, and send the report to the leader AP or other control entities in the CG through the AP communication modules 735. In some embodiments, the channel monitoring component 760 may track various channel conditions, including signal strength, noise levels, interference measurements, channel utilization, bit rate, and data throughput rate, among others. The channel monitoring component 760 may evaluate whether the channel coherence time (Tc) has expired or, if before Tc expires, whether changes in channel conditions have caused the similarity to drop below a defined percentage (e.g., 90% similarity). In some embodiments, the QDepth monitoring component 765 may be configured to track QDepth progress since the last report. The QDepth progress may refer to the extent to which packets in each STA's queue, present at the time of generating the last report, have been served. The number of packets served after the last report may be determined by analyzing changes in sequence numbers or timestamps of the packets. Once data is collected, the QDepth monitoring component 765 may compare the QDepth progress with a predefined threshold to assess whether the reduction in queue depth has reached a level considered significant enough to warrant updated reporting.

The processor 705 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 705 processes information received through the transceiver 745, the AP communication module 735, and the network communication module 720. The processor 705 retrieves and executes programming instructions stored in memory 710, as well as stores and retrieves application data residing in storage 715.

The storage 715 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 715 may store a variety of data for efficient functioning of the system. The data may include queue status data 775 (e.g., queue lengths, sequence numbers, timestamps), channel condition data 780 (e.g., RSSI, noise levels), and reporting criteria (e.g., Tc, QDepth threshold).

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method for managing network traffic within a coordination group (CG), comprising:
receiving, by a follower network device in the CG, a reporting criterion from a leader network device in the CG;
sending, by the follower network device, a first queue statistics report to the leader network device;
monitoring, by the follower network device, at least one of one or more channel conditions of a wireless network within the CG or one or more queue depth (QDepth) progresses related to the follower network device;
detecting, by the follower network device, a deviation from the reporting criterion based on the monitoring; and
sending, by the follower network device, a second queue statistics report to the leader network device.

2. The method of claim 1, wherein the reporting criterion comprises a channel coherence time (Tc), comprising:
a set of values that define thresholds for the one or more channel conditions, and
an expiration time indicating when the set of values should be reassessed or when the Tc expires.

3. The method of claim 2, wherein detecting the deviation comprises at least one of:
detecting changes in the one or more channel conditions exceeding the thresholds defined in the Tc, or
detecting the expiration time being reached.

4. The method of claim 1, further comprising, subsequent to detecting the deviation, collecting queue status data from one or more client devices, each associated with the follower network device, wherein the queue status data are included within the second queue statistics report.

5. The method of claim 1, wherein the reporting criterion comprises a QDepth threshold.

6. The method of claim 5, wherein detecting the deviation comprises detecting at least one of the one or more QDepth progresses exceeding the QDepth threshold.

7. The method of claim 1, wherein the first queue statistics report comprises a sequence number of a packet, and wherein the packet is a first packet in a queue at a time of generating the first queue statistics report, and is awaiting to be transmitted by a client device to the follower network device.

8. The method of claim 7, wherein monitoring the one or more QDepth progresses comprises comparing the sequence number within the first queue statistics report with a sequence number of a new packet, wherein the new packet is the first packet in the queue at a time of monitoring the QDepth progress, and is awaiting to be transmitted by the client device to the follower network device.

9. The method of claim 1, wherein the first queue statistics report comprises a timestamp of a packet, and wherein the packet is a first packet in a queue at a time of generating the first queue statistics report, and is awaiting to be transmitted by a client device to the follower network device.

10. The method of claim 9, wherein monitoring the one or more QDepth progresses comprises comparing a timestamp within the first queue statistics report with a timestamp of a new packet, wherein the new packet is the first packet in the queue at a time of monitoring the QDepth progress, and is awaiting to be transmitted by the client device to the follower network device.

11. The method of claim 1, wherein the follower network device comprises an access point (AP), and the leader network device comprises at least one of an AP, a router, or a wireless controller (WLC).

12. The method of claim 1, wherein the one or more channel conditions comprise at least one of signal strength, noise level, interference pattern, channel utilization, and bit rate.

13. The method of claim 1, wherein the queue statistics report comprises at least one of current queue statuses, traffic load data related to devices associated with the follower network device, or changes in the one or more channel conditions.

14. The method of claim 1, wherein the leader network device adjusts resource allocations within the CG based on the second queue statistic report.

15. The method of claim 1, wherein the first and second queue statistics reports are sent by the follower network device out of a scheduled transmission opportunity (TXOP).

16. A system of a follower network device within a coordination group (CG), comprising:
one or more computer processors; and
one or more memories collectively containing one or more programs, which, when executed by the one or more computer processors, perform operations, the operations comprising:
receiving a reporting criterion from a leader network device in the CG;
sending a first queue statistics report to the leader network device;
monitoring at least one of one or more channel conditions of a wireless network within the CG or one or more queue depth (QDepth) progresses related to the follower network device;
detecting a deviation from the reporting criterion based on the monitoring; and
sending a second queue statistics report to the leader network device.

17. The system of claim 16, wherein the reporting criterion comprises a channel coherence time (Tc), comprising:
a set of values that define thresholds for the one or more channel conditions, and
an expiration time indicating when the set of values should be reassessed or when the Tc expires.

18. The system of claim 17, wherein, to detect the deviation, the one or more programs, which, when executed by the one or more computer processors, perform the operations comprising:
detecting changes in the one or more channel conditions exceeding the thresholds defined in the Tc, or
detecting the expiration time being reached.

19. The system of claim 16, wherein the reporting criterion comprises a QDepth threshold, and wherein, to detect the deviation, the one or more programs, which, when executed by the one or more computer processors, perform the operations comprising detecting at least one or more QDepth progresses within the follower network device exceeding the QDepth threshold.

20. One or more non-transitory computer-readable media containing, in any combination, computer program code that, when executed by operation of a computer system, performs operations comprising:
receiving, by a follower network device in a coordination group (CG), a reporting criterion from a leader network device in the CG;
sending, by the follower network device, a first queue statistics report to the leader network device;
monitoring, by the follower network device, at least one of one or more channel conditions of a wireless network within the CG or one or more queue depth (QDepth) progresses related to the follower network device;
detecting, by the follower network device, a deviation from the reporting criterion based on the monitoring; and
sending, by the follower network device, a second queue statistics report to the leader network device.
